(19) United States
(12) Patent Application Publication
(10) Pub. No.: US 2006/0251071 A1
(43) Pub. Date: Nov. 9, 2006

(54) Apparatus and method for IP packet processing using network processor

(76) Inventors: Jong-Sang Oh, Suwon-si (KR); Sun-Shin An, Seoul (KR); Woo-Jin Park, Seoul (KR); Dae-Hee Kim, Seoul (KR); Sun-Gi Kim, Seoul (KR)

Correspondence Address: Robert E. Bushnell, Suite 300, 1522 K Street, N.W., Washington, DC, 20005, US

(21) Appl. No.: 11/385,825

(22) Filed: Mar. 22, 2006

(30) Foreign Application Priority Data
Mar. 22, 2005 (KR) 2005-23827

(51) Int. Cl. H04L 12/56

(52) U.S. Cl. 370/390

(57) ABSTRACT

An apparatus and method for processing Internet protocol (IP) packets using a network processor, wherein functions of the network processor are dynamically allocated to threads according to an amount of received packets by a type thereof. As a result, the use efficiency of the network processor is improved, and the speed of processing of the packets is increased accordingly.

### CLAIM OF PRIORITY

This application makes reference to, incorporates the same herein, and claims all benefits accruing under 35 U.S.C. §119 from an application for APPARATUS AND METHOD FOR IP PACKET PROCESSING USING NETWORK PROCESSOR earlier filed in the Korean Intellectual Property Office on Mar. 22, 2005 and there duly assigned Serial No. 2005-23827.

### BACKGROUND OF THE INVENTION

1. Technical Field

The present invention relates to an apparatus and method for Internet protocol (IP) packet processing using a network processor and, more particularly, to an apparatus and method for IP packet processing using a network processor and capable of improving the use efficiency of the network processor and the speed of processing the packets.

2. Related Art

Generally, network devices have been developed by use of an application specific integrated circuit (ASIC). However, the network devices developed by use of an ASIC chip were able to use only functions provided by the ASIC chip, and for use of those functions, there was no choice but to preset register values provided by the ASIC chip. Accordingly, it had no use in modifying the existing functions or realizing new functions. That is, for the pre-developed ASIC based network devices that were used for construction of a network based on a silicon chip, it was in fact impossible to provide new functions and performance improvement, and there was also a limit on the amount of packet processing. Consequently, the existing network devices have not been adapted to present networks in which the transmission rating and the type of services supported have increased with the appearance of new types of services, such as the integration of voice and data and of wire and wireless Internet, and the like.

Accordingly, new network devices based on a network processor of a next generation chip have appeared. The network processor is a programmable processor capable of processing packets received from a user input interface, i.e., an input port, in various methods before transporting the same to an output user interface, i.e., an output port. The processor is also a specialized packet processor which has the advantages of providing high performance processing capacity for packets at an ASIC level, and of immediately reflecting the various demands of network users through a program. That is, the network processor can provide a programming function with respect to traffic transported between ports and intelligent switching in network devices, such as a router, a switch and so forth. As a result, it may be the basis of next generation network devices as a non-memory chip capable of providing various multi-media Internet traffic services. Generally, the network processor can be configured to include a plurality of micro engines, each including a plurality of threads. Of course, a network processor including only a single thread may be used. However, it is ineffective so that it is general practice not to use the same.

Thus, there is a problem in the prior art in that the network processor cannot be used effectively.

### SUMMARY OF THE INVENTION

It is, therefore, an object of the present invention to provide an apparatus and a method for IP packet processing using a network processor and capable of improving the use efficiency of the network processor and the speed of processing packets as well.

To achieve the above and other objects, there is provided an apparatus for processing received Internet protocol (IP) packets using a network processor, the apparatus comprising: at least one thread for performing an operation according to an allocated function; a packet classifier for determining whether the received packets are IPv4 packets, IPv6 unicast packets or IPv6 multicast packets; and a controller for measuring the amount of the received IPv4 packets and IPv6 unicast packets, and the amount of the received IPv6 multicast packets, according to a result of the previous determination, for determining a function to be allocated to the thread according to the measured amount of packets, and for allocating the determined function to the thread.

In accordance with another aspect of the present invention, there is provided a method for processing Internet protocol (IP) packets using a network processor including a thread capable of dynamic function allocation, the method comprising the steps of: determining whether the received packets are IPv4 packets, IPv6 unicast packets or IPv6 multicast packets; measuring an amount of the received IPv4 packets and IPv6 unicast packets, and an amount of IPv6 multicast packets, according to a result of the previous determination; determining a function to be allocated to the thread capable of dynamic function allocation according to the measured amount of packets; and allocating the determined function to the thread, allowing the thread to be operated according to the allocated function.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram of an apparatus for processing Internet protocol (IP) packets including a network processor;

FIG. 2 is a diagram of an exemplary application of a network processor;

FIG. 3 is a diagram of an exemplary application of a network processor according to the present invention;

FIG. 4 is a flowchart of a procedure of function allocation for a network processor according to a first embodiment of the present invention;

FIG. 5 is a flowchart of a procedure of function allocation for a network processor according to a second embodiment of the present invention; and

FIG. 6 is a flowchart of an operating procedure of a network processor operating according to an allocated function.

### DETAILED DESCRIPTION OF THE INVENTION

Hereinafter, the preferred embodiments of the present invention will be described in detail with reference to the drawings. In describing the present invention, if it is determined that the detailed description of a related known function or construction renders the scope of the present invention unnecessarily ambiguous, the detailed description thereof will be omitted.

The present invention as described hereinafter relates to an apparatus for processing Internet protocol (IP) packets using a network processor which dynamically allocates a micro engine and a thread of the network processor, i.e., resources of the network processor, according to the amount of received packets by type thereof, so that the use efficiency of the network processor is improved and the speed of processing of the packets is therefore increased.

Hereinafter, the present invention will be explained with reference to an example employing the IXP2400 network processor of Intel. IXP2400 introduced a new concept allowing the user to conduct program coding with the provision of an instruction cache memory in the network processor. That is, the network processor can be realized adaptively for usage of an application wherein a network processor is applied. This program is called a micro code. The micro code is an assembly language executable in IXP2400. The micro code is performed so that, if a realized code is downloaded to the instruction cache memory, each of the micro engines of the network processor receives an instruction from the instruction cache memory, and performs the instruction. The micro engines of the network processor are composed of eight engines, and the micro codes of the respective micro engines are realized according to the usage thereof with the number of engines being selected according to the user's desire.

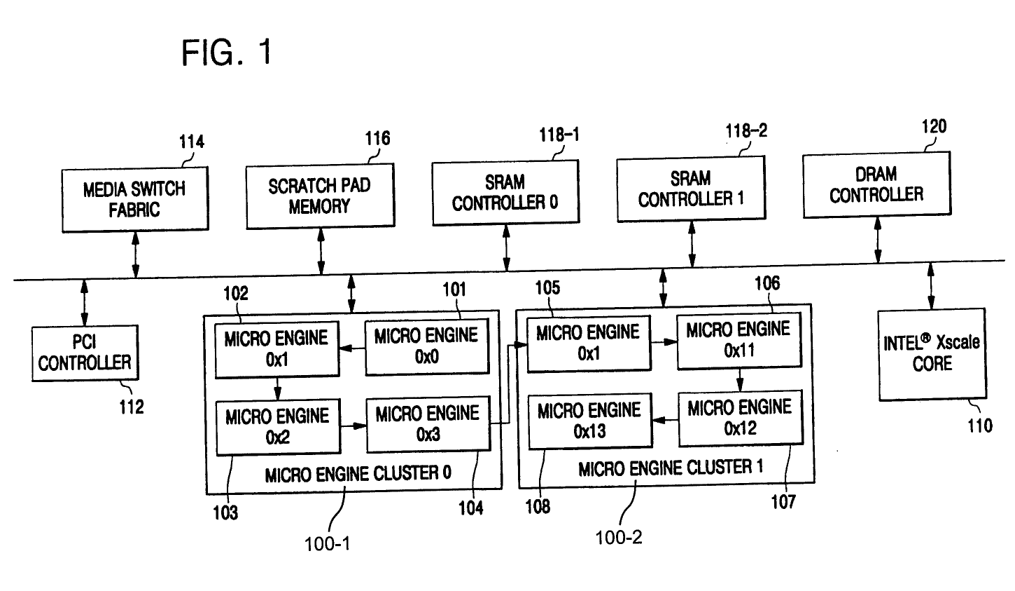

FIG. 1 is a diagram of an apparatus for processing Internet protocol (IP) packets, the apparatus including a network processor.

More specifically, FIG. 1 shows a network processor including eight micro engines 101 thru 108, each having eight threads. The network processor shown in FIG. 1 is configured to include two micro engine clusters 100-1 and 100-2, each having four micro engines 101 thru 104 and 105 thru 108, respectively. The thread of the network processor is a working unit wherein one packet is allocated and processed. The packet processing using such network processor will be described below.

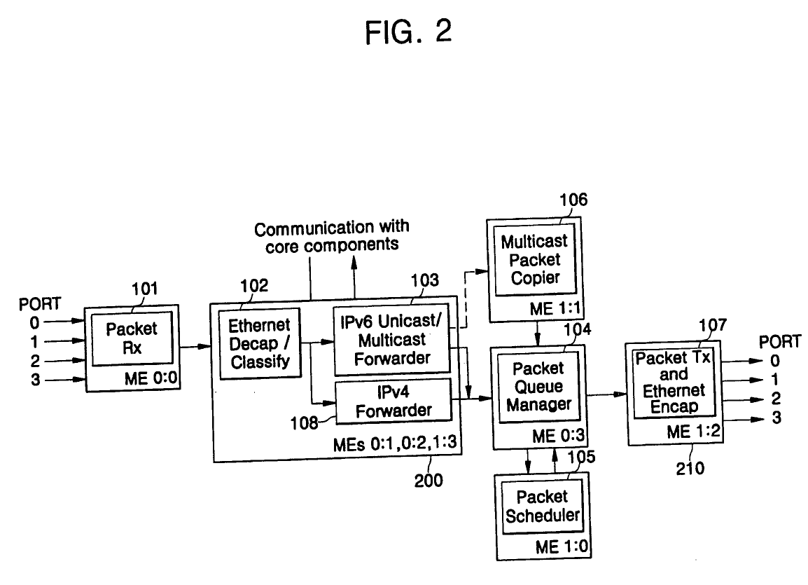

FIG. 2 is a diagram of an exemplary application of a network processor.

More specifically, FIG. 2 shows an exemplary application of the network processor in a network in which IPv4 and IPv6 packets co-exist. As shown in FIG. 2, the eight micro engines 101 thru 108 of the network processor can be used as a packet receiver (packet Rx) 101, a packet classifier (Ethernet Decap/Classify) 102, an IPv6 packet forwarder (IPv6 Unicast/Multicast Forwarder) 103, a packet queue manager 104, a packet scheduler 105, a multicast packet copier 106, a packet transmitter (packet Tx and Ethernet Encap) 107 and an IPv4 packet forwarder 108. It should be noted that, in FIG. 2, the reference numerals 101 thru 108 of the micro engines are provided to the respective function parts in order to assist in an understanding of the use of the network processor.

The packet receiver 101 performs a frame re-assembly of the packets inputted through a media interface.

The packet classifier 102 decapsulates the input packets, and classifies the received packets for a type and a service grade according to quality of service (QoS) with reference to headers of the respective packets. The packet classifier 102 determines whether the received packet is an IPv4 packet or an IPv6 packet, and outputs the corresponding packet to the IPv6 packet forwarder 103 or the IPv4 packet forwarder 108 according to a result of the determination. Meanwhile, if the received packet is an address resolution protocol (ARP) packet, the packet classifier 102 outputs the corresponding packet to an Intel Xscale core 110 (FIG. 1).

The IPv6 packet forwarder 103 performs a longest prefix match (LPM) for the unicast packet so as to output it to the packet queue manager 104, and searches a route table for the multicast packet to ascertain the number of an output interface, and to output it to the multicast packet copier 106 so as to perform packet copying by a corresponding number.

The IPv4 packet forwarder 108 forwards the IPv4 packet based on L3 addressing so as to output it to the packet queue manager 104. Herein, the packet classifier 102, the IPv6 packet forwarder 103 and the IPv4 packet forwarder 108 can be commonly called a packet forwarder 200.

The packet queue manager 104 and the packet scheduler 105 perform the buffering and scheduling for the packet forwarded from the IPv6 packet forwarder 103 or the IPv4 packet forwarder 108 so as to output it to the packet transmitter 107. The packet transmitter 107 encapsulates the input packet to output it to a corresponding output interface.

The multicast packet copier 106 performs a function of copying the IPv6 multicast packet in accordance with a number of the destination. The multicast packet copier 106 copies the packet by the number as required only when it is determined that the multicast packet is required to be transmitted to at least two output interfaces according to a lookup result of the route of the IPv6 packet forwarder 103. Packets copied from the multicast packet copier 106 are also encapsulated in the packet transmitter 107 through the packet queue manager 104 for output via a network.

The micro engines 101 thru 108 or threads of the network processor have respective functions allocated to them, and perform the allocated functions. However, in the event that functions are fixedly allocated to the respective micro engines 101 thru 108 of the network processor to process the IPv4 packet or IPv6 packet, the following problem may result.

The amount of IPv4 packets or IPv6 packets transmitted via the network can be varied occasionally, and the amount of IPv6 unicast packets or IPv6 multicast packets can also be varied from time to time. However, if the amount of IPv6 multicast packets is particularly large, an overhead may be generated with respect to the multicast packet copier 106. This is due to the fact that the IPv6 multicast packets should be copied according to the number of the output interface. That is, if the amount of the received IPv6 multicast packets is larger than that of the received IPv4 packets or IPv6 unicast packets, an overhead may be generated at the packet copier 106 and there may be a thread that is not used in the packet forwarder 200.

In further detail, FIG. 1 shows a block diagram of THE IXP2400 network processor. As shown in FIG. 1, THE IXP2400 network processor includes eight multi-thread packet processing micro engines 101 thru 108, an intel Xscale core 110, a peripheral component interconnect (PCI) controller 112, a media switch fabric 114, a scratch pad memory 116, static random access memory (SRAM) controllers 118-1 and 118-2, and a dynamic random access memory (DRAM) controller 120. The eight micro engines 101 thru 108 are programmable packet processors, which support up to eight multi-threading per each engine. The respective micro engines 101 thru 108 perform various network processing functions with hardware, and process data at optical carrier (OC)-48 wire speed. The INTEL Xscale core 110 is a 32-bit reduced instruction set computing (RISC) core for high performance processing, such as exception handling of packets, performance of complex algorithms, maintenance of route tables, and the like, and the SRAM controller 118 and the DRAM controller 120 perform management of easy access to an SRAM and a DRAM, respectively, storing the routing table or various data structures. The media switch fabric 114 is connected to a framer and media access control (MAC) device, or a switch fabric. The PCI controller 112 manages communication with an external host processor or other chips connected via a PCI bus.

Each of the eight multi-thread packet processing micro engines 101 thru 108 operates while being allocated to a function such as packet receiving, packet forwarding, IPv6 multicast packet copying, packet queue managing, packet scheduling, packet transmitting, and the like. In function allocation for the micro engines 101 thru 108, the present invention determines the micro engine and thread performing packet forwarding or IPv6 multicast packet copying in consideration of the amount of received IPv4/IPv6 unicast packets and received IPv6 multicast packets, and allocates the corresponding function to a micro engine and the thread according to the latter determination. The apparatus for processing IP packets using the network processor according to the present invention, in which the function allocation for the network processor is performed dynamically, will be explained hereinafter with reference to accompanying drawings.

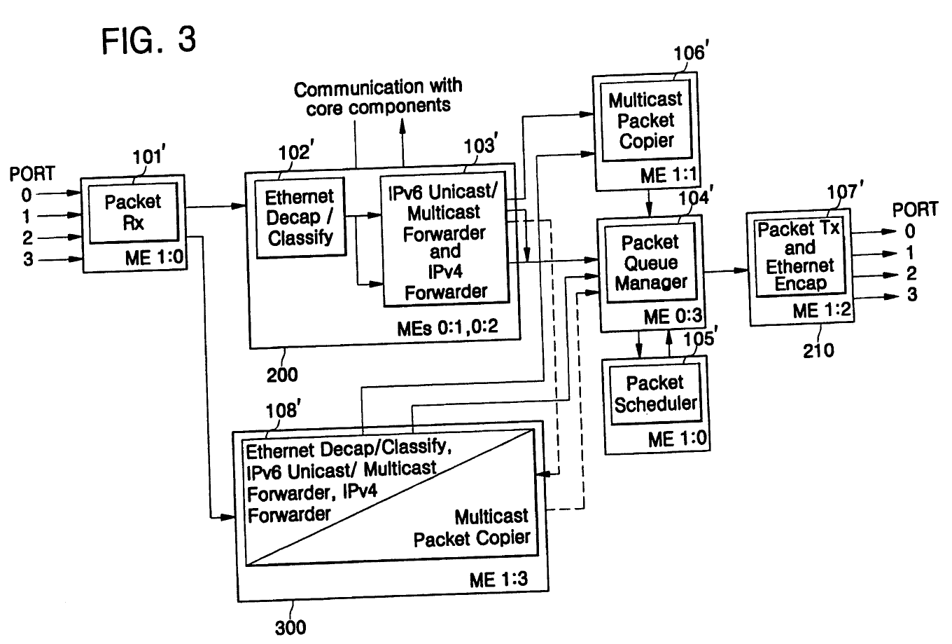

FIG. 3 is a diagram of an exemplary application of a network processor according to the present invention.

As shown in FIG. 3, seven of the eight micro engines 101 thru 107 of the network processor can be used as a packet receiver (packet Rx) 101′, a packet classifier (Ethernet Decap/classify) 102′, an IPv4 packet and IPv6 packet forwarder (IPv6 Unicast/Multicast Forwarder) 103′, a packet queue manager 104′, a packet scheduler 105′, a multicast packet copier 106′, and a packet transmitter (packet Tx and Ethernet Encap) 107′.

The packet receiver 101′ performs a frame re-assembly of the packets inputted through a media interface.

The packet classifier 102′ decapsulates the input packets, and classifies the received packets for a type and a service grade according to quality of service (QoS) with reference to headers of the respective packets. The packet classifier 102′ can determine whether the received packet is an IPv4 packet or an IPv6 packet.

IPv6/IPv4 packet forwarder 103′ performs a longest prefix match (LPM) for the IPv6 unicast packet so as to output it to the packet queue manager 104′, and searches a route table for the IPv6 multicast packet to ascertain the number of an output interface and to output it to the multicast packet copier 106′ so as to perform packet copying by corresponding number. In addition, the IPv6/IPv4 packet forwarder 103′ forwards the IPv4 packet based on L3 addressing so as to output it to the packet queue manager 104′.

The packet queue manager 104′ performs an enqueue/dequeue operation to an SRAM queue for packet time traffic, and the packet scheduler 105′ selects the packet to be transmitted to a media switch fabric interface according to a proper algorithm, and requests the packet queue manager 104′ for dequeue.

The packet transmitter 107′ performs an encapsulation, adding a 2-layer header to a packet payload, and transmits the packets through the media switch fabric 114 (FIG. 1) while dividing the same into a single packet or multipacket (MPKT)

The multicast packet copier 106′ performs copying of IPv6 multicast packets in accordance with the number of the corresponding output interface. The muilticast packet copier 106′ copies the packet by number as required only when it is determined that the corresponding multicast packet is required to be transmitted to at least two output interfaces according to a lookup result of the route of the IPv6 packet forwarder 103′. Packets copied from the multicast packet copier 106′ are also encapsulated at the packet transmitter 107′ through the packet queue manager 104′ for output via a network.

As described above, among the eight micro engines 101 thru 108 of the network processor, seven micro engines 101 thru 107 are allocated respective functions, but the other micro engine 108 is not allocated a function. The micro engine 108 to which a function is not allocated is hereinafter called a “variable function micro engine”. In FIG. 3, the variable function micro engine 108′ can perform any allocated function such as packet decapsulation and classification, IPv6 unicast/IPv6 multicast packet forwarding, IPv4 packet forwarding, and IPv6 multicast packet copying. If the IPv6 multicast packets are received in quantity, the variable function micro engine 108′ is allocated the function of IPv6 multicast packet copying. If IPv4/IPv6 unicast packets are received in quantity, the variable function micro engine 108′ is allocated the function of packet forwarding.

Hereinafter, the measuring of the amount of received packets according to type thereof, and a function allocation to the variable function micro engine 108′ according to the measurement result, will be explained.

The type of received IP packet can be classified by the packet classifier 102′. The packet classifier 102′ can determine whether the received packet is an IPv4 packet, an IPv6 unicast packet or an IPv6 multicast packet by reference to the header of the received packet. The measuring of the amount of packets according to the type of the received packets can be performed in such a manner that, as each packet is received, a count value for the corresponding packet is increased. Intel Xscale core 110 (FIG. 1) can perform such measuring as indicated above by increasing a count value as a function of a controller of the present invention.

That is, the controller of the IP packet processing apparatus using the network processor according to the present invention increases the count value by 1 in order to measure the amount of IPv4 packets and IPv6 unicast packets when an IPv4 packet or an IPv6 unicast packet is received, and it increases the count value by 1 to measure the amount of IPv6 multicast packets when an IPv6 multicast packet is received. The controller determines which function is allocated to the variable function micro engine 108′ by use of the count value counted for each packet. If the count value of the IPv4/IPv6 unicast packets is so large that it exceeds a certain reference value, the controller allocates the function of packet forwarding to the variable function micro engine 108′, and if the count value of the IPv6 multicast packets is so large that it exceeds another certain reference value, the controller allocate the function of multicast packet copying to the variable function micro engine 108′. The controller can determine a function to be allocated to the variable function micro engine 108′ according to a ratio of IPv4/IPv6 unicast packet amount to IPv6 multicast packet amount. Herein, a certain function is allocated to the variable function micro engine 108′ according to the reference value or the ratio of the IPv4/IPv6 unicast packet to IPv6 multicast packet, a preferred reference value being selected according to features of the system, and so a detailed explanation thereof is omitted. In addition, in function allocation to the variable function micro engine 108′, the controller can be constructed so that it does not allocate the packet forwarding function or the multicast packet copying function to all of the eight threads of the variable function micro engine 108′, but rather it allocates the packet forwarding function to some of the threads and the multicast packet copying function to other threads. This is because function allocation can be performed for every thread. The function allocation to the variable function micro engine 108′ can be performed by changing of specific register values corresponding to the respective threads. The threads of the variable function micro engine 108′ perform the respective functions allocated thereto. Consequently, dynamic resource allocation for the network processor can be realized according to the amount of received packets by type thereof.

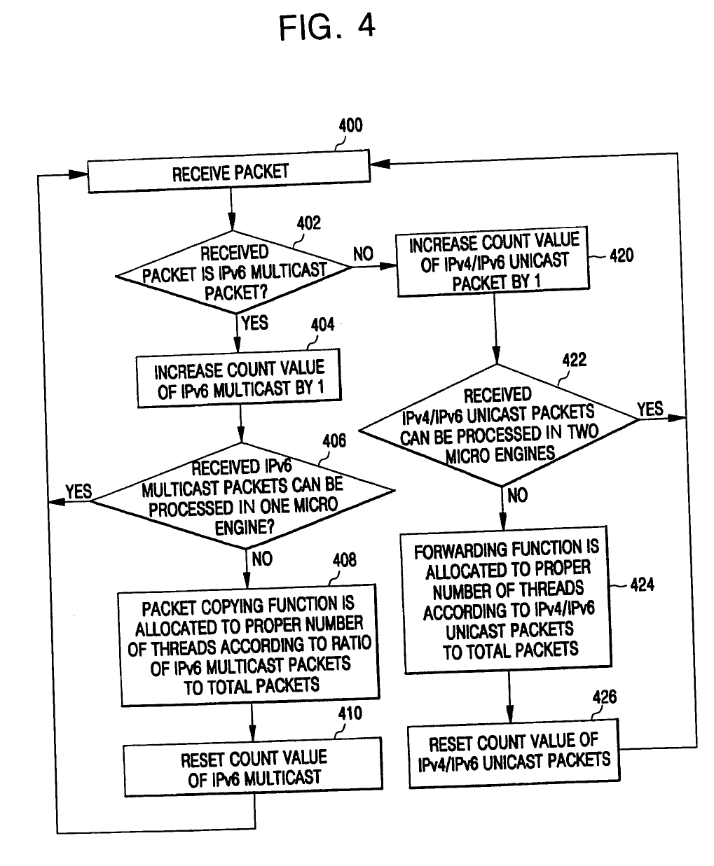

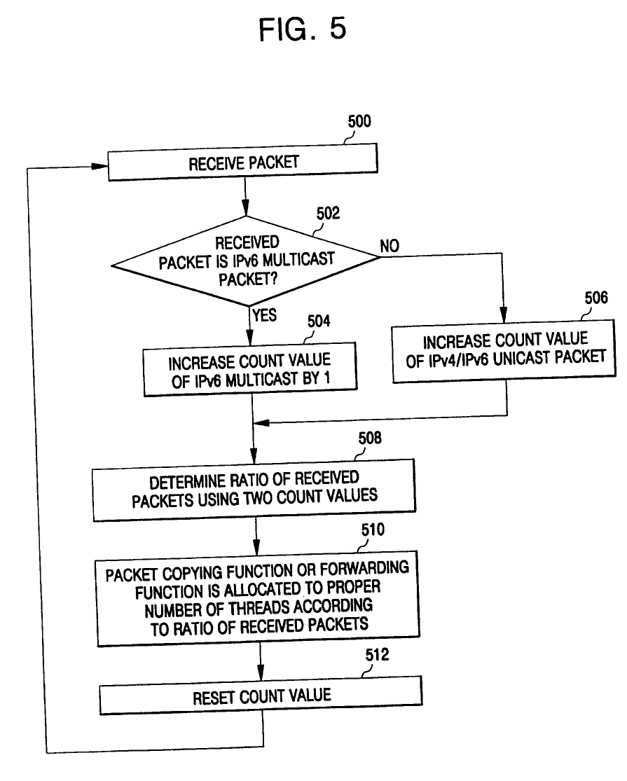

Hereinafter, the operation of the IP packet processing apparatus using the network processor according to the present invention will be explained with reference to FIGS. 4 and 5 of the accompanying drawings.

FIG. 4 is a flowchart of a procedure of function allocation for a network processor according to a first embodiment of the present invention, and FIG. 5 is a flowchart of a procedure of function allocation for a network processor according to a second embodiment of the present invention.

More specifically, FIGS. 4 and 5 show the process of determining which function, between the forwarding function and the multicast packet copying function, is allocated to the respective eight threads of the micro engine, and process of practically allocating functions dynamically to the eight threads. Thus, FIG. 4 is a flow chart of a first embodiment which comprises the measured packet amount by type thereof with a certain reference value, and determines which function is allocated to the variable function micro engine 108′, and FIG. 5 is a flow chart of a second embodiment which comprises the measured amount of IPv4/IPv6 unicast packets with the amount of IPv6 multicast packets, and determines which function is allocated to the variable function micro engine 108′ according to the comparison result.

Referring to the first embodiment of FIG. 4, in step 400, a packet is received, and the type of received packet is determined in step 402. If the received packet is determined to be an IPv6 multicast packet, the count value for measuring the amount of the IPv6 multicast packet is increased by 1 in step 404. In step 406, it is determined whether the received IPv6 multicast packet can be processed in one micro engine with reference to the count value. If it is determined that the amount of the received IPv6 multicast packets cannot be processed in one micro engine, step 408 is performed so that, for the threads of the variable function micro engine 108′, the multicast packet copying function is allocated to a proper number of threads according to the ratio of IPv6 multicast packets to the total packets. After the function allocation to the variable function micro engine 108′ in step 408, the count value of IPv6 multicast packet is reset in step 410. If, as a result of step 406, it is determined that the amount of received IPv6 multicast packets can be processed in one micro engine, the function allocation is not performed for the variable function micro engine 108′, and a return to step 400 is executed.

Returning to step 402, if it is determined that the received packet is an IPv4 packet or an IPv6 unicast packet, rather than an IPv6 multicast packet, the count value of IPv4/IPv6 unicast packets is increased in step 420. Then, in step 422, it is determined whether the amount of the received IPv4/IPv6 unicast packets can be processed in two micro engines. If it is determined that the received IPv4/IPv6 unicast packets cannot be processed in two micro engines, step 424 is performed so that, for the threads of the variable function micro engine 108′, the packet forwarding function is allocated to a proper number of threads according to the ratio of IPv4/IPv6 unicast packets to the total packets. After performance of step 424, the count value of IPv4/IPv6 unicast packets is reset in step 426, and a return to step 400 is executed.

Referring to the second embodiment of FIG. 5, a function to be allocated to the variable function micro engine 108′ is determined by a comparison of the amount of IPv4/IPv6 unicast packets with the amount of IPv6 multicast packets. Steps 500, 502, 504 and 506 are substantially identical to steps 400, 402, 404 and 420, respectively, of FIG. 4, and thus a detailed explanation of those steps will be omitted.

In step 508 the ratio of the count value of IPv4/IPv6 unicast packets to that of IPv6 multicast packets is determined, and step 510 allocates the multicast packet copying function or the packet forwarding function to the proper number of threads, among the threads of the variable function micro engine 108′, according to the determined ratio. Thus, in step 512, a count value is reset.

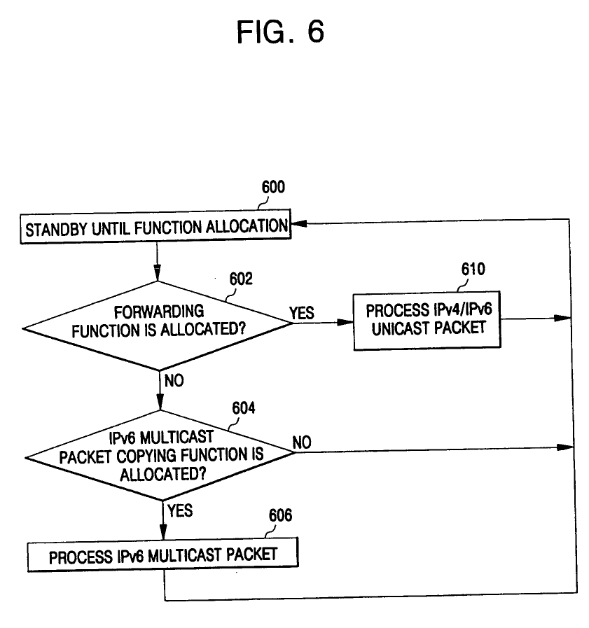

FIG. 6 is a flowchart of an operating procedure of a network processor operating according to an allocated function.

In step 600 of FIG. 6, the thread of the variable function micro engine 108′ is on standby until a function is allocated to it. When allocated with a function, the thread of the variable function micro engine 108′ operates according to the allocated function. If it is determined in step 602 that the packet forwarding function is allocated to it, the packet forwarding function of IPv4/IPv6 unicast packets is performed in step 610. Conversely, it is determined in step 602 that a packet forwarding function is not allocated, and if it is determined in step 604 that the packet copying function of IPv6 multicast packets is allocated to the thread of the variable function micro engine 108′, the thread performs the packet copying function of input IPv6 multicast packets in step 606. After execution of steps 606 or 610, or if step 604 results in a determination that the IPv6 multicast packet copying function is not allocated, a return to step 600 is executed.

The apparatus and method for processing IP packets using the network processor according to the present invention has been heretofore described with reference to an example in which a function to be performed by the threads of one micro engine, among the eight micro engines of the Intel IXP2400 network processor (each micro engine having eight threads), is dynamically allocated in consideration of the amount of received IPv6 multicast packets and IPv4/IPv6 unicast packets. The present invention, however, can be expanded and adapted to an apparatus and method for processing IP packets using a network processor other than the Intel IXP2400 network processor. In addition, in the present invention, the number of threads and micro engines is not limited to that described above. Of course, the number of the micro engin to be set as the variable function micro engine is not limited to the number “1”.

As described before, the present invention provides effects that a network processor which can be used effectively in packet processing, and the speed of processing packets is therefore increased.

While the invention has been described in conjunction with various embodiments, they are illustrative only. Accordingly, many alternatives, modifications and variations will be apparent to persons skilled in the art in light of the foregoing detailed description. The foregoing description is intended to embrace all such alternatives and variations falling with the spirit and broad scope of the appended claims.

What is claimed is:

1. An apparatus for processing received Internet protocol (IP) packets using a network processor, said apparatus comprising:
at least one thread for performing an operation according to an allocated function;
a packet classifier for determining whether the received IP packets are IPv4 packets, IPv6 unicast packets or IPv6 multicast packets; and
a controller for measuring an amount of received IPv4 packets and IPv6 unicast packets, and an amount of received IPv6 multicast packets, according to a result of the determination by the packet classifier, for determining a function to be allocated to said at least one thread according to the measured amount of the received packets, and for allocating the determined function to said at least one thread.

2. The apparatus according to claim 1, wherein said at least one thread is allocated one of a packet forwarding function and an IPv6 multicast packet copying function, and performs an operation according to the allocated function.

3. The apparatus according to claim 1, wherein the packet classifier determines whether the received IP packets are the IPv4 packets, the IPv6 unicast packets or the IPv6 multicast packets by referring to headers of the received packets.

4. The apparatus according to claim 1, wherein, when a received packet is determined to be one of the IPv4 packet and the IPv6 unicast packet, the controller increases a corresponding count value by 1 so as to measure an amount of said one of the IPv4 packet and the IPv6 unicast packet, and when the received packet is determined to be the IPv6 multicast packet, the controller increases another corresponding count value by 1 so as to measure an amount of the IPv6 multicast packet, thereby measuring the amount of received packets according to a type thereof.

5. The apparatus according to claim 1, wherein, when the measured amount of the received IPv4 packets and IPv6 unicast packets exceeds a certain reference value, the controller allocates a packet forwarding function to said at least one thread.

6. The apparatus according to claim 1, wherein, when the measured amount of the received IPv6 multicast packet exceeds a certain reference value, the controller allocates the multicast packet copying function to said at least one thread.

7. The apparatus according to claim 1, wherein the controller determines whether said at least one thread is allocated the packet forwarding function or the multicast packet copying function according to a ratio of the amount of the received IPv4 packets and IPv6 unicast packets to the amount of the received IPv6 multicast packets.

8. The apparatus according to claim 1, wherein said at least one thread comprises a plurality of threads, and wherein the controller allocates the packet forwarding function to some of the threads and the multicast packet copying function to other threads, according to an amount of received packets by a type thereof.

9. The apparatus according to claim 1, wherein the controller allocates a function to said at least one thread by setting a specific register value corresponding to said at least one thread.

10. An apparatus for processing received Internet protocol (IP) packets using an Intel IXP2400 network processor which includes eight micro engines, each having eight threads, said apparatus comprising:
a first micro engine for performing an operation according to an allocated function;
a second micro engine for performing a packet classifier function for determining whether the received IP packets are IPv4 packets, IPv6 unicast packets or IPv6 multicast packets; and
a controller for measuring an amount of received IPv4 packets and IPv6 unicast packets, and an amount of received IPv6 multicast packets, according to a result of the determination by the second micro engine, for determining a function to be allocated to the first micro engine according to the measured amount of received packets, and for allocating the determined function to the first micro engine.

11. The apparatus according to claim 10, wherein the first micro engine is allocated one of a packet forwarding function and an IPv6 multicast packet copying function, and performs an operation according to the allocated function.

12. The apparatus according to claim 10, wherein the second micro engine determines whether a received IP packet is an IPv4 packet, an IPv6 unicast packet or an IPv6 multicast packet by referring to a header of the received IP packet.

13. The apparatus according to claim 10, wherein, when the measured amount of the received IPv4 packets and the IPv6 unicast packets exceeds a certain reference value, the controller allocates the packet forwarding function to the first micro engine.

14. The apparatus according to claim 10, wherein, when the measured amount of the received IPv6 multicast packets exceeds a certain reference value, the controller allocates the multicast packet copying function to the first micro engine.

15. The apparatus according to claim 10, wherein the controller determines whether the first micro engine is allocated the packet forwarding function or the multicast packet copying function according to a ratio of the amount of the received IPv4 packets and IPv6 unicast packets to the amount of the received IPv6 multicast packets.

16. The apparatus according to claim 10, wherein the controller allocates the packet forwarding function to some of the eight threads of the first micro engine and the multicast packet copying function to others of the eight threads of the first micro engine according to an amount of received packets by a type thereof.

17. A method for processing Internet protocol (IP) packets using a network processor which includes at least one thread capable of dynamic function allocation, said method comprising the steps of:
(a) determining whether received packets are IPv4 packets, IPv6 unicast packets or IPv6 multicast packets;
(b) measuring an amount of the received IPv4 packets and IPv6 unicast packets, and an amount of IPv6 multicast packets, according to a result of step (a);
(c) determining a function to be allocated to said at least one thread capable of dynamic function allocation according to a measured amount of received packets; and
(d) allocating the determined function to said at least one thread, thereby allowing said at least one thread to be operated according to the allocated function.

18. The method according to claim 17, wherein step (a) is performed by referring to headers of the received packets

19. The method according to claim 17, wherein step (b) includes increasing a count value of a corresponding packet 1 according to a type of a received packet when each of said packets is received.

20. The method according to claim 17, wherein steps (c) and (d) are performed in such a manner that, when the measured amount of the received IPv4 packets and IPv6 unicast packets exceeds a certain reference value, a packet forwarding function is allocated to said at least one thread.

21. The method according to claim 17, wherein steps (c) and (d) are performed in such a manner that, when the measured amount of the received IPv6 multicast packets exceeds a certain reference value, a multicast packet copying function is allocated to the thread.

22. The method according to claim 17, wherein said at least one thread comprises a plurality of threads, and wherein steps (c) and (d) are performed in such a manner that a packet forwarding function is allocated to some of the threads and the multicast packet copying function is allocated to others of the threads according to an amount of received packets by a type thereof.
